(19) United States
(12) Patent Application Publication
(10) Pub. No.: US 2024/0391486 A1
(43) Pub. Date: Nov. 28, 2024

(54) SYSTEM FOR LEARNING-BASED PROCESSING OF RADAR DATA

(71) Applicant: Zendar Inc., Berkeley, CA (US)

(72) Inventors: Michael Robert Kellman, Berkeley, CA (US); Mohammadreza Mostajabi, Albany, CA (US); Ching Ming Wang, El Cerrito, CA (US)

(21) Appl. No.: 18/202,162

(22) Filed: May 25, 2023

(51) Int. Cl. B60W 60/00; G01S 13/50

(52) U.S. Cl. CPC B60W 60/001; G01S 13/505; B60W 2420/408

(57) ABSTRACT

The present disclosure provides a system for processing radar data. The system may comprise a vehicle located in an environment; a radar module associated with the vehicle; and an electronic processor configured to: receive, from the radar module, an incoming radar signal comprising digitized radar samples that include a first indication of objects in the environment; process the incoming radar signal through one or more signal processing algorithms to determine a raw radar spectrum; process the raw radar spectrum through a machine-learning computational model to determine a set of output predictions for the environment; determine a scene representation and a scene understanding based at least in part on the set of output predictions for the environment; and provide the scene representation and the scene understanding to an autonomous driving system.

### BACKGROUND

Radio Detection and Ranging (radar) can be used in many applications including object detection, range-finding, direction-finding, and mapping. Traditionally, radar has been used in aerial vehicles, satellites, and maritime vessels to locate objects and image terrain. In recent years, radar has become increasingly popular in automobiles for applications such as blind-spot detection, collision avoidance, and autonomous driving. Unlike optical-based sensors (such as cameras or Light Detection and Ranging (LIDAR) systems) which are affected by changing weather and visibility, radar functioning in low light conditions, in the dark, and under all types of weather conditions.

### SUMMARY

Embodiments of the present disclosure are generally directed to systems and methods that determined a three three-dimensional (3D) scene representation of an environment by processing incoming radar signals through a machine-learning computational model.

Recognized herein are various limitations with radar systems currently available. In order to take advantage of radar, vehicles may be equipped with multiple radar and other type sensors to detect obstacles and objects in the surrounding environment. However, the multiple radar sensors in current radar systems may typically process data independently of one another. Provided herein are systems and methods for processing and combining radar data as well as data received from other sensors (e.g., imaging, LIDAR, and the like). The performance and robustness of radar systems may be improved by combining data from multiple sensors or modules prior to the perception, detection, or classification of objects or obstacles in a surrounding environment. Further, the radar systems disclosed herein may be configured to resolve computational ambiguities involved with processing and coherently combining radar data from multiple radar sensors or modules, in order to identify nearby objects or obstacles and generate one or more local maps of the surrounding environment.

Modern vehicles (e.g., autonomous, semi-autonomous, or human-driven vehicles) rely on a combination of cameras and 3D sensors with data-driven methodologies to measure and extract information about the environment. Information from one or more cameras provide dense semantic information about the environment. 3D range sensors (e.g., LIDAR or radar) provide complementary information to camera data such as range. However, camera and LIDAR technologies are severely limited in acclimate weather conditions, and camera technology is further limited to daytime applications. Radar is an active-sensing 3D sensing technology similar to LIDAR but operates in the radio frequency (RF) band and does not share LIDAR's shortcomings. Additionally, radar offers ego velocity (longitudinal velocity) and target velocity information over other 3D sensing technologies such as LIDAR. In some embodiments, the ego velocity is the speed of the vehicle to which the system is mounted.

Generally, radar is employed in vehicles (e.g., an automobile) to implement certain driving functions such as maintaining speed and distance from a vehicle ahead (e.g., adaptive cruise control), braking when a collision is likely (e.g., emergency braking assistance), or warning the driver when another vehicle is in a blind spot. In order to implement these functions, a scene understanding is determined. A scene understanding may include the presence or absence of the target, a target's location in 3D space, a target's bounding box (e.g., the physical extent and dimensions in 3D space), a target's orientation, a target's direction of travel, a target's velocity of travel, a category or type of target, whether the target is moving or stationary, the velocity of travel of the vehicle where the radar sensor is mounted, and the like. Radar can also be used to generate scene representations of the environment, such as free space (e.g., the drivable area) maps of the environment that indicate, for example, where objects are present and where no objects are present.

Traditional radar processing assumes that the world is made of point-like reflective objects. This assumption allows radar system designers to apply traditional signal processing algorithms (e.g., Fourier transforms, window functions, detection, and maximum likelihood estimation) by neglecting the complexity of the real world. An example processing pipeline may first compute a sparse point cloud that fits the point-like assumption and then attempt to predict target properties from this point cloud representation. However, that information lost in the process of converting radar data to a sparse point cloud significantly limits the performance of down-stream perception applications such as 3D object detection, ego-motion, velocity estimation, and the like.

In contrast, as described herein, machine-learning algorithms can be applied to raw radar data, without computing a point cloud, to enable new applications and increased performance in areas where traditional automotive radar algorithms struggle. Generally, machine-learning algorithms include algorithms that are trained through an optimization process that adjusts the parameters and weights of the algorithm to increase its performance. Examples of machine learning algorithms include deep neural networks, convolutional neural networks, recurrent neural networks, long-short term memory networks, and transformer networks. Using machine learning algorithms within vehicle radar implementations can improve the performance, fidelity, and latency when determining target properties and environment properties compared to conventional radar methods.

In some embodiments, the described radar imaging system evaluates a neural network to determine the desired output(s) from a set of given inputs. In some embodiments, the neural network may be preceded or followed by conventional radar algorithms such as signal processing or rule-based perception algorithms. In some embodiments, the neural network is trained to compute properties from a radar signal. In some embodiments, these properties correspond to properties of targets in the environment such as bounding box, category or type, direction of travel, velocity of travel, and the like. In other embodiments, the properties which the neural network computes are an intermediate representation that, upon further processing, can be used to compute a target-specific property.

During a training phase, in some embodiments, a neural network is evaluated based on input data for which the output is known and the weights of the neural network are optimized so that the neural network provided an output that most closely corresponds to these known outputs. In some embodiments, a loss or cost function is employed to compare and evaluate the output of the neural network against the desired or known output. In other embodiments, the neural network is evaluated based on input data for which the output is not known. In such embodiments, the loss function includes radar system information, which is employed to optimize the neural network weights by comparing the output to the input.

In some embodiments, the training phase includes ingesting large amounts of real-world data to optimize the performance of the neural network. During this training phase, the neural network learns the most relevant features in the input data that best correlate to and predict the desired outputs. In some embodiments, the features that are learned by the neural network are automatically identified by allowing the training process to converge.

Training a neural network typically requires curation of a large amount of real-world data where the expected outputs (i.e., labels) of the neural network can already be determined. However, producing real-world data labels by hand is challenging and expensive at large scale. Moreover, in the case of radar data, hand labeling is further complicated by the fact that unlike camera or LIDAR data, annotating radar spectrum is non-intuitive. Accordingly, automatic labeling methodologies employed herein enable large-scale dataset creation. In some embodiments, automatic labeling may employ additional sensors (e.g., a camera or LIDAR) to provide 3D scene context for radar to use as ground truth labels. Moreover, unsupervised/self-supervised techniques can be employed for automatic labeling in the radar space.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more embodiments of the present disclosure are set forth in the accompanying drawings and the description below. Other features and advantages of the present disclosure will be apparent from the description and drawings, and from the claims.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede or take precedence over any such contradictory material.

### BRIEF DESCRIPTION OF THE DRAWINGS

A better understanding of the features and advantages of the present subject matter will be obtained by reference to the following detailed description that sets forth illustrative embodiments and the accompanying drawings (also “Figure” and “FIG.” herein) of which:

FIG. 1 depicts a system for processing radar data, in accordance with some embodiments;

FIG. 2 depicts a system configured to process radar data from a subset of a plurality of radar modules, in accordance with some embodiments;

FIG. 3 depicts a non-limiting exemplary computer system that can be programmed or otherwise configured to implement methods or systems of the present disclosure; and

FIG. 4 depict flowcharts of a non-limiting exemplary process that can be implemented by embodiments of the present disclosure.

### DETAILED DESCRIPTION

While various embodiments of the disclosure have been shown and described herein, it will be obvious to those skilled in the art that such embodiments are provided by way of example only. Numerous variations, changes, and substitutions may occur to those skilled in the art without departing from the disclosure. It should be understood that various alternatives to the embodiments of the disclosure described herein may be employed.

### Certain Definitions

Unless otherwise defined, all technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, the term “real-time” refers to transmitting or processing data without intentional delay given the processing limitations of a system, the time required to accurately obtain data and images, and the rate of change of the data and images. In some examples, “real-time” is used to describe the presentation of information obtained from components of embodiments of the present disclosure.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

### Target Detection/Classification

The described system may be configured to detect or classify one or more targets in a surrounding environment. Detecting a target may involve identifying a presence of a target in a vicinity of the vehicle. Classifying a target may involve determining whether a target is stationary or moving or determining whether or not the target is positioned relative to the vehicle such that the target obstructs or partially obstructs a path of motion of the vehicle. A target may be any object external to the vehicle. A target may be a living being or an inanimate object. A target may be a pedestrian, an animal, a vehicle, a building, a signpost, a sidewalk, a sidewalk curb, a fence, a tree, or any object that may obstruct a vehicle travelling in any given direction. A target may be stationary, moving, or capable of movement.

A target may be located in the front, rear, or lateral side of the vehicle. A target may be positioned at a range of at least about 1 meter (m), 2 m, 3 m, 4 m, 5 m, 10 m, 15 m, 20 m, 25 m, 50 m, 75 m, or 100 m from the vehicle. A target may be located on the ground, in the water, or in the air. A target may be located on or near a motion path of the vehicle. A target may be oriented in any direction relative to the vehicle. A target may be orientated to face the vehicle or oriented to face away from the vehicle at an angle ranging from Oto about 360 degrees. In some cases, a target may comprise multiple targets external to a terrestrial vehicle.

A target may have a spatial disposition or characteristic that may be measured or detected. Spatial disposition information may include information about the position, velocity, acceleration, or other kinematic properties of the target relative to the terrestrial vehicle. A characteristic of a target may include information on the size, shape, orientation, or material properties of the target. Material properties may include reflectivity or a radar cross section of the target. In some cases, a characteristic of a target may comprise a measurement of an angle of arrival of the target relative to the vehicle. The angle of arrival may correspond to an elevation angle or an azimuth angle associated with an incoming radar signal that is reflected from the target and received at the vehicle.

In some embodiments, a target may have a size of at least 0.2 meters, be in a side facing direction of a terrestrial vehicle, and be at least about 1 meter from a terrestrial vehicle. In some embodiments, a target may have a size of at least 0.2 meters, be in a forward or rear facing direction of a terrestrial vehicle, and be at least about 1 meter from a terrestrial vehicle. A surrounding environment may be a location or setting in which the vehicle may operate. A surrounding environment may be an indoor or outdoor space. A surrounding environment may be an urban, suburban, or rural setting. A surrounding environment may be a high altitude or low altitude setting. A surrounding environment may include settings that provide poor visibility (nighttime, heavy precipitation, fog, particulates in the air). A surrounding environment may include targets that are on a travel path of a vehicle. A surrounding environment may include targets that are outside of a travel path of a vehicle.

### Example System

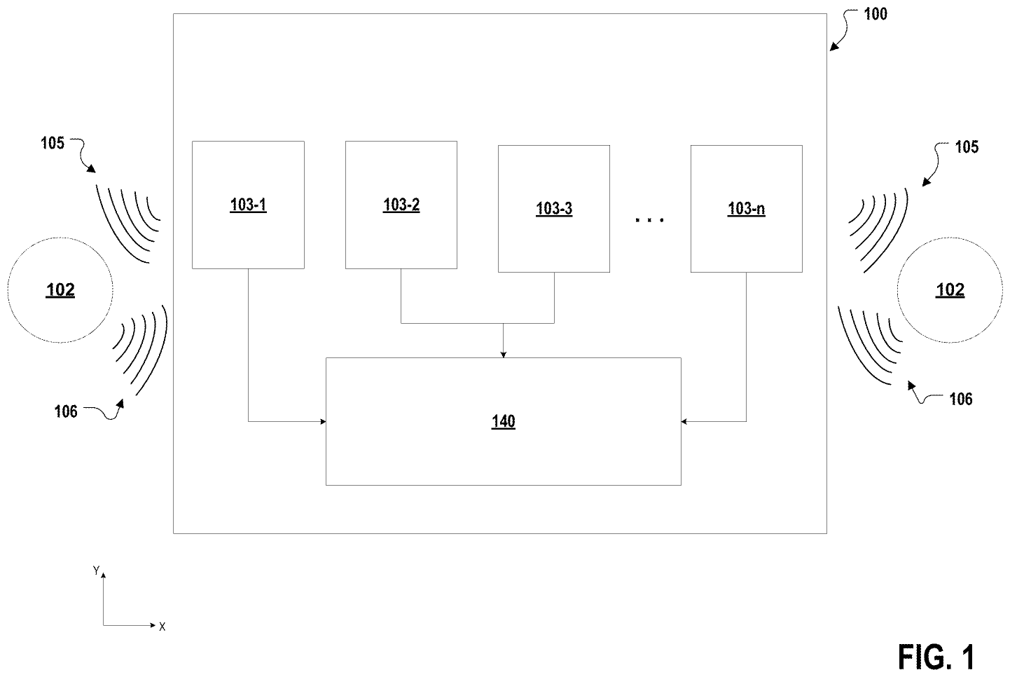

FIG. 1 depicts an example of a system 100 for processing radar data. The system 100 may comprise a processor 140 communicably coupled to a plurality of radar modules 130-1, 130-2, 130-3, and so on, up to an nth radar module 130-n where n may be any integer. In some cases, n may be greater than or equal to 1, 2, 3, 4, 5, 6, 7, 8, 9, 10, or more. Each of the plurality of radar modules may be configured to transmit a first set of signals. The first set of signals may comprise a plurality of outgoing radar pulses 105. Each of the plurality of radar modules may be configured to receive a second set of signals reflected from a target 102 in a surrounding environment. The second sets of signals may be a subset of the first sets of signals transmitted by each of the plurality of radar modules and may be generated upon the subset of the first sets of signals interacting with or reflecting off of a target 102. The second sets of signals may comprise a plurality of incoming radar pulses 106.

The plurality of radar modules 130-n may each comprise a radar transmitter or a radar receiver. The radar transmitter may comprise a transmitting antenna. The radar receiver may comprise a receiving antenna. A transmitting antenna may be any antenna (dipole, directional, patch, sector, Yagi, parabolic, grid) that can convert electrical signals into electromagnetic waves and transmit the electromagnetic waves. A receiving antenna may be any antenna (dipole, directional, patch, sector, Yagi, parabolic, grid) that can receive electromagnetic waves and convert the radiofrequency radiation waves into electrical signals. In some cases, each of the radar modules 130-n may include one or more transmitting antennas or one or more receiving antennas. In some cases, each of the radar modules 130-n may have a plurality of RX or TX channels. The radar modules 130-n may be used to detect one or more targets in a surrounding environment. In some cases, each of the radar modules 130-n may include an imaging device (e.g., a camera).

Each radar module of the plurality of radar modules 103-n may be configured to transmit a first set of radar signals comprising a plurality of outgoing radar pulses. The plurality of outgoing radar pulses may comprise a radar pulse. A radar pulse may be any electromagnetic wave or signal transmitted by a radar module within a frequency range of about 1 hertz (Hz) to about 300 gigahertz (GHz). In some cases, the plurality of outgoing radar pulses may have a frequency of 24 GHz, 60 GHz, or 79 GHz.

The system 100 may further comprise a processor 140 operatively coupled to and in communication with each of the plurality of radar modules. Each of the plurality of radar modules may be configured to provide the second sets of radar signals or the plurality of incoming radar pulses 106 respectively received by each of the plurality of radar modules to the processor 140. In some embodiments, the processor 140 is configured to process the incoming radar pulses 106 received by the radar signals radar modules 103-n through a series of trained algorithms that include, for example, a machine-learning computational model. In some embodiments, the incoming radar pulses 106 include one or more of the following: raw time domain signal (fast time x slow time x antenna channel), range-Doppler spectrum (e.g., range x Doppler x (virtual/real) antenna channel), or beam spectrum (e.g., range x Doppler x azimuth angle x elevation angle). In some embodiments, the radar signals representation can also be a real or complex value. In some embodiments, a range-Doppler spectrum is the same as a raw radar spectrum where the data axes are range and Doppler. In some embodiments, a beam spectrum is the same as a raw radar spectrum where the data axes are range, Doppler, and azimuth and/or elevation (e.g., azimuth=horizontal angle; elevation=vertical angle).

In some embodiments, the processor 140 is configured to process the incoming radar pulses 106 through one or more signal processing steps before being processing the incoming radar pulses 106 through a trained neural network. Example signal processing steps include Fourier transforms, filtering, interpolation, extrapolation, downsampling, upsampling, resampling, windowing, parameter estimation, subspace decomposition, maximum likelihood estimation, thresholding, and the like. In some embodiments, the processor 140 is configured to process the incoming radar pulses 106 through one or more signal processing steps after processing the incoming radar pulses 106 through a trained neural network. In some embodiments, the processor 140 is configured to include, as input to the machine-learning computational model, a history of the incoming radar pulses 106 (e.g., last N frames) in addition to the incoming radar pulses 106. Generally, a radar senses the world through snapshots referred to herein as frames. Multiple frames may correspond to successive snapshots of the sensor. In some embodiments, the machine-learning computational model in configured to learn the time-fusion of the incoming radar pulses 106 when the history is provided. In some embodiments, the radar modules 130-n may have overlapping fields of view. In some embodiments, machine-learning computational model is configured to learn the spatial fusion of the spatially distributed radar pulses 106 when the incoming radar pulses 106 are received from multiple radar modules 130-n.

In some embodiments, the processor 140 is configured to provide the output of the series of trained algorithms to an autonomous driving system. In some embodiments, the autonomous driving system includes an emergency braking system, an advance driving assistant system (ADAS), or an active safety system. In some embodiments, a machine-learning computational model is configured to provide as output one or more of the following: a point cloud; a detection mask (e.g., that breaks up and labels the incoming radar pulses 106 as either signal or noise components); a data spectrum that includes, for example, range, Doppler, azimuth angle, or elevation angle; clusters of points; clusters of points with estimated tracks; point-specific features that include, for example, range, Doppler, ground speed, ground velocity, azimuth angle, elevation angle, height, or object class (e.g., car, pedestrian, truck, motorcycle, and the like); object-specific features that include, for example, type, size, shape, orientation, bounding box, speed, velocity, acceleration, turn rate, and the like; ego-vehicle properties that include, for example, turn rate, velocity, acceleration, speed, and the like; environment properties that include, for example, the vehicle's safe drivable area.

In some embodiments, the processor 140 is configured to generate an occupancy grid using the output of the series of trained algorithms to an autonomous driving system. An occupancy grid may be a visual representation of the surrounding environment in which the radar system operates. The occupancy grid may represent where in space one or more objects have been detected relative to a position or orientation of the vehicle. The occupancy grid may represent the presence of one or more objects in the surrounding environment and in a vicinity of the vehicle. The occupancy grid may show the positions or orientations of the one or more objects relative to a position or orientation of the vehicle. The vehicle may be stationary or in motion. In some cases, the occupancy grid may be generated or updated based on a movement of the vehicle through the surrounding environment.

In some embodiments, the machine-learning computational model receives, as an input, the incoming radar pulses 106. The architecture of the machine-learning computational model may take any of a number of forms, such as a neural network model (e.g., a convolutional neural network model (CNN), long short-term memory (LSTM)) or a Vision Transformer (ViT) model. Different kernel sizes (e.g., a kernel size between 3 and 20) and numbers of blocks (e.g., four blocks in the descending portion of the “U” of the U-NET architecture) may be used or adjusted as suitable. In some embodiments, the machine-learning computational model includes a data-driven, machine-learned neural network. In some embodiments, the data-driven machine-learned neural network includes a multi-level network whose performance improves as it processes more data. In some embodiments, the neural network includes learnable parameters that are double precision, single precision, half precision or 8-bit precision

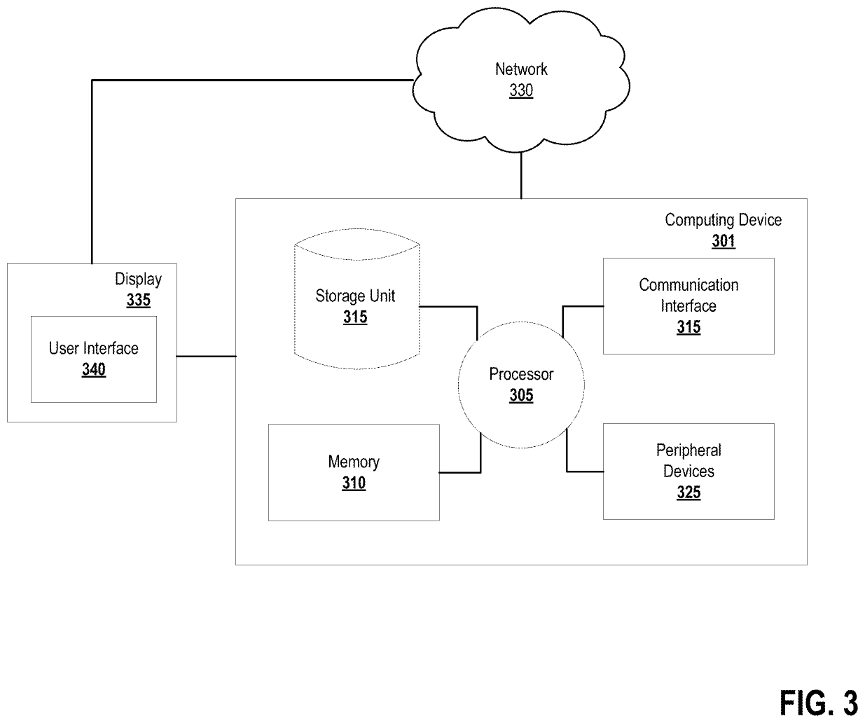

In some embodiments, the machine-learning computational model is trained using a body of training data that includes raw radar spectrum data generated manually or otherwise. In some embodiments, raw radar spectrum data includes a) one or more of the following quantities: signal amplitude, complex amplitude, phase, power, and/or signal to noise ratio, or b) measured over one or more of range, Doppler, azimuth angle, and elevation angle. In some embodiments, the machine-learning computational model is retrained upon the receipt of additional radar pulses. Any suitable training technique for machine-learning computational models may be implemented, such as a gradient descent process using suitable loss functions. In some embodiments, the output of the machine-learning computational model is employed to retrain the machine-learning computational model using dropout or other regularization methods. In some embodiments, the training data is reserved for use in validation and in assessing when training is complete. In some embodiments, machine-learning computational models are retrained on a regular chronological schedule (e.g., every week), after a certain number of confirmed incoming radar pulses are accumulated (e.g., 200), in accordance with any other suitable schedule, or at the command of a user (e.g., received via a UI, such as the user interface (UI) 340 of FIG. 3).

In some embodiments, the machine-learning computational model is trained using labels from, for example, a supervised method with hand-labeled methods (e.g., where a user assigns radar data with the desired labels), supervised learning using automatic labeling methods with other sensors (e.g., cameras, lidars, Global Positioning System (GPS) sensors, or an inertial measurement unit (IMU)). In some embodiments, the output from the machine-learning computational model is compared with the output from one or more of the sensors listed above. For example, object labels (e.g., person, car, bike) obtained from lidar point clouds and camera images are associated with the radar point cloud and used as a training signal by projection into the radar space. As another example, to learn how to differentiate signal from noise, LIDAR can be associated with radar points by their spatial proximity to assess whether a radar point is a true detection or a false alarm.

In some embodiments, the machine-learning computational model is trained using unsupervised/self-supervised methods by learning, for example, how to reconstruct the raw radar signal from multiple radars or from multiple data points in time. In some embodiments, mathematical models of radar physics are used to train the machine-learning computational model by enforcing that the model's learned feature space be consistent with the physics of radar. As an example, autoencoder-like architectures can be used to achieve meaningful latent space variables including estimates of the object's direction of arrival and velocity as well as our motion. This can be achieved by using a physical radar simulation that relates how an object's 3D location and velocity produces a radar complex-valued beam spectrum as the decoder of the network. In some embodiments, a mixture of one or more of the above-described training methods is employed. For example, an unsupervised method can be employed to learn the network weights and a supervised method to fine tune the network, along with human-labeled data to capture challenging corner cases.

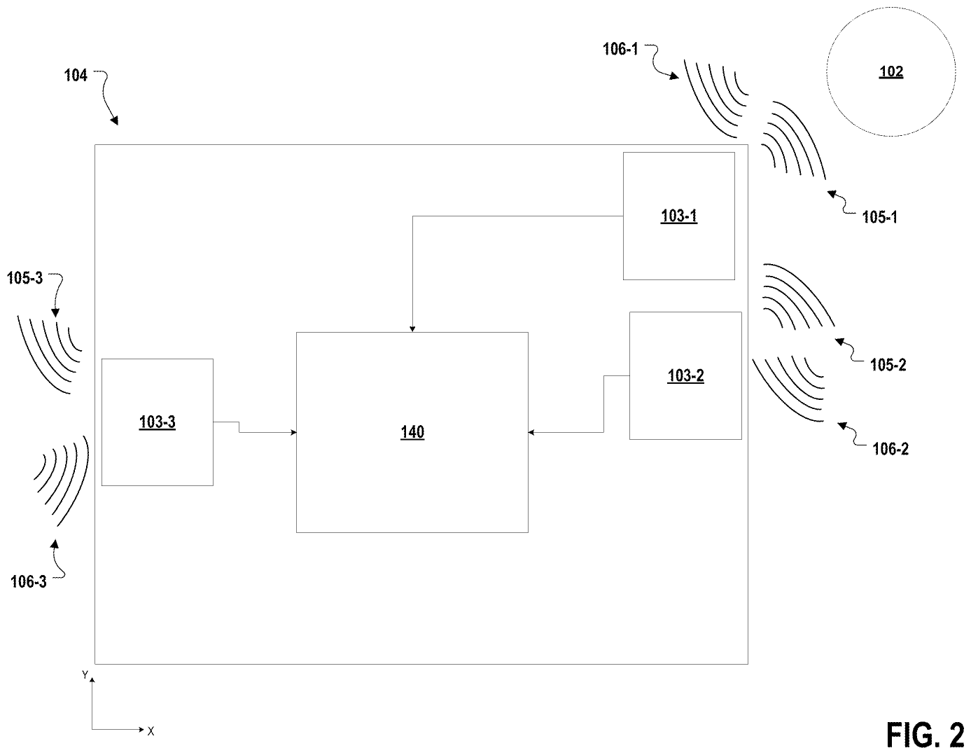

FIG. 2 illustrates a system configured to process radar data from a subset of a plurality of radar modules 130-1, 130-2, and 130-3. The particular number and arrangement of the radar modules depicted in FIG. 2 is simply illustrative, and any number and arrangement of radar modules may be included within a system for processing radar data.

The plurality of radar modules 130-1, 130-2, and 130-3 may be mounted to any side of a vehicle 104, or to one or more sides of a vehicle 104 (e.g., a front side, a rear side, a lateral side, a top side, or a bottom side of the vehicle). The mounting position of the plurality of radar modules 130-1, 130-2, and 130-3 may be determined based on driving conditions, type of vehicle, use cases, and the like.

The front side of the vehicle may be the side that is facing a general direction of travel of the vehicle 104, while a rear (or back) side may be the side that is not facing the general direction of travel of the vehicle 104. The rear side may be opposite to the front side of the vehicle. The front side of the vehicle may point towards a forward direction of travel of the vehicle 104. The rear side of the vehicle may point towards a rear direction of travel (e.g., reverse) of the vehicle 104. The lateral side may include a left side or a right side of the vehicle. The vehicle 104 may or may not be configured to move or translate orthogonally to the lateral sides of the vehicle. In some cases, the plurality of radar modules 130-1, 130-2, and 130-3 may be mounted between two adjacent sides of the vehicle.

The plurality of radar modules 130-1, 130-2, and 130-3 may be oriented to detect one or more targets 102 in front of the vehicle 104, behind the vehicle 104, to the lateral sides of the vehicle 104, above the vehicle 104, below the vehicle 104, or within a vicinity of the vehicle 104. In some cases, each of the plurality of radar modules 130-1, 130-2, and 130-3 may be configured to be mounted on the same side or different sides of the vehicle 104. For example, one or more radar modules 130-1, 130-2, and 130-3 may be mounted on the top, bottom, front side, rear side, or lateral sides of the vehicle 104. In some cases, each of the plurality of radar modules 130-1, 130-2, and 130-3 may be configured to be mounted in the same or different orientations. For example, one or more radar modules 130-1, 130-2, and 130-3 may be oriented to detect one or more targets 102 in front of the vehicle 104, behind the vehicle 104, to the sides of the vehicle 104, above the vehicle 104, or below the vehicle 104.

The vehicle 104 may be any type of machine that transports people or cargo. Example vehicles include, but are not limited to, wagons, bicycles, motor vehicles, tractors, mining vehicles, railed vehicles, construction equipment, watercraft, amphibious vehicles, aircraft, spacecraft, and the like. The vehicle 104 may be operated by a living subject, such as an animal (e.g., a human). The vehicle 104 may be stationary, moving, or capable of movement.

The vehicle 104 may be any suitable terrestrial vehicle, aerial vehicle, or aquatic vehicle. A terrestrial vehicle may be a motor vehicle or any other vehicle that uses a source of energy, renewable or nonrenewable (e.g., solar, thermal, electrical, wind, petroleum, and the like), to move across or in close proximity to the ground, such as, for example, within 1 meter, 2 meters, 3 meters of the ground. An aerial vehicle may be a motor vehicle or any other vehicle that uses a source of energy, renewable or nonrenewable, (solar, thermal, electrical, wind, petroleum, and the like) to move through the air or through space. An aquatic vehicle may be a motor vehicle or any other vehicle that uses a source of energy, renewable or nonrenewable, (solar, thermal, electrical, wind, petroleum, and the like) to move across or through water.

In some embodiments, the vehicle 104 is a land-bound vehicle capable of travel over land. For example, the vehicle 104 may be an automobile. Alternatively or in addition, the vehicle 104 may be capable of traveling on or in water, or underground. In some embodiments, the vehicle 104 is a land-bound vehicle, watercraft, aircraft, or spacecraft. The vehicle 104 may travel freely over a surface. The vehicle 104 may travel freely within two or more dimensions. The vehicle 104 may primarily drive on one or more roads. In some cases, the vehicle 104 is capable of operating in the air or in space. For example, the vehicle 104 may be a plane or a helicopter.

In some embodiments, the vehicle 104 is an unmanned vehicle and may operate without requiring a human operator. In some embodiments, the vehicle 104 may have no passenger or operator on-board. In some embodiments, the vehicle 104 includes a space within which a passenger may ride. In some embodiments, the vehicle 104 includes a space for cargo or objects. In some embodiments, the vehicle 104 includes tools that permit the vehicle to interact with the environment (e.g., collect samples, move objects, and the like). In some embodiments, the vehicle 104 includes tools that emit objects to the surrounding environment (e.g., light, sound, liquids, or pesticides).

In some embodiments, the vehicle 104 is a self-driving vehicle. In some embodiments, the vehicle 104 is an autonomous, or semi-autonomous vehicle. An autonomous vehicle may be an unmanned vehicle. The autonomous vehicle may or may not have a passenger or operator on-board the vehicle. The autonomous vehicle may or may not have a space within which a passenger may ride. The autonomous vehicle may or may not have space for cargo or objects to be carried by the vehicle. The autonomous vehicle may or may not have tools that may permit the vehicle to interact with the environment (e.g., collect samples, move objects). The autonomous vehicle may or may not have objects that may be emitted to be dispersed to the environment (e.g., light, sound, liquids, pesticides, and the like). The autonomous vehicle may operate without requiring a human operator. The autonomous vehicle may be a fully autonomous vehicle or a partially autonomous vehicle.

In some embodiments, the vehicle 104 may permit one or more passengers to ride on-board. In some embodiments, the vehicle 104 includes a space for one or more passengers to ride the vehicle. In some embodiments, the vehicle 104 includes an interior cabin with space for one or more passengers. In some embodiments, the vehicle 104 includes a space for a driver of the vehicle. In some embodiments, the vehicle 104 is capable of being driven by a human operator. In some embodiments, the vehicle 104 is operated using an autonomous driving system.

In some embodiments, the vehicle 104 may switch between a manual driving mode during which a human driver may drive the vehicle, and an autonomous driving mode during which an automated controller may generate signals that operate the vehicle without requiring intervention of a human driver. In some embodiments, the vehicle 104 provides driver assistance where the driver may primarily manually drive the vehicle, but the vehicle may execute certain automated procedures or assist the driver with performing certain procedures (e.g., lane changes, merging, parking, auto-braking). In some embodiments, the vehicle 104 has a default operation mode. For example, the manual driving mode may be a default operation mode, or an autonomous driving mode may be a default operation mode.

As illustrated in FIG. 2, the plurality of radar modules 130-1, 130-2, and 130-3 may be configured to transmit the first sets of radar signals comprising a plurality of outgoing radar pulses 105-1, 105-2, and 105-3. The plurality of radar modules 130-1, 130-2, and 130-3 may be configured to receive a second sets of radar signals comprising a plurality of incoming radar pulses 106-1, 106-2, and 106-3. The plurality of radar modules 130-1, 130-2, and 130-3 may be operatively coupled to and in communication with a processor 140. The plurality of radar modules 130-1, 130-2, and 130-3 may be configured to provide the second sets of radar signals or the plurality of incoming radar pulses 106-1, 106-2, and 106-3 respectively received by each of the plurality of radar modules to the processor 140. The is configured to process the incoming radar pulses 106 received by the radar signals radar modules through a machine-learning computational model. In some embodiments, the machine-learning computational model is local to the vehicle 104. In some embodiments, the machine-learning computational model is accessed via a cloud or local server. In some embodiments, the machine-learning computational model is trained in real-time during data collection by the processor 140 via a cloud infrastructure. In some embodiments, the machine-learning computational model is trained offline after data has been transferred to a local or cloud data servers.

### Computer Systems

Another aspect of the present disclosure provides computer systems that are programmed or otherwise configured to implement methods of the disclosure. FIG. 3 depicts a computer system 301 that is programmed or otherwise configured to implement platforms, systems, media, and methods of the present disclosure. For example, the computing device 510 can be programmed or otherwise configured to processing radar data. The computer system 301 can be an electronic device of a user or a computer system that is remotely located with respect to the electronic device. The electronic device can be a mobile electronic device.

The computer system 301 may include a central processing unit (CPU, also “processor” and “computer processor” herein) 305, which can be a single core or multi core processor, or a plurality of processors for parallel processing. The computer system 301 also includes memory or memory location 310 (e.g., random-access memory, read-only memory, flash memory), electronic storage unit 315 (e.g., hard disk), communication interface 320 (e.g., network adapter) for communicating with one or more other systems, and peripheral devices 325, such as cache, other memory, data storage or electronic display adapters.

The memory 310, storage unit 315, interface 320 and peripheral devices 325 are in communication with the CPU 305 through a communication bus (solid lines), such as a motherboard. The storage unit 315 can be a data storage unit (or data repository) for storing data. The computer system 301 can be operatively coupled to a computer network (“network”) 330 with the aid of the communication interface 320.

The network 330 can be the Internet, an internet or extranet, or an intranet or extranet that is in communication with the Internet. The network 330 in some cases is a telecommunication or data network. The network 330 can include one or more computer servers, which can enable distributed computing, such as cloud computing. The network 330, in some cases with the aid of the computer system 301, can implement a peer-to-peer network, which may enable devices coupled to the computer system 301 to behave as a client or a server.

The CPU 305 can execute a sequence of machine-readable instructions, which can be embodied in a program or software. The instructions may be stored in a memory location, such as the memory 310. The instructions can be directed to the CPU 305, which can subsequently program or otherwise configure the CPU 305 to implement methods of the present disclosure. Examples of operations performed by the CPU 305 can include fetch, decode, execute, and writeback. The CPU 305 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, hardware accelerators, or any other suitable processing devices. The CPU 305 can be part of a circuit, such as an integrated circuit. One or more other components of the system 301 can be included in the circuit. In some cases, the circuit is an application specific integrated circuit (ASIC) or a Field-programmable gate array (FPGA).

The storage unit 315 can store files, such as drivers, libraries, and saved programs. The storage unit 315 can store user data, e.g., user preferences and user programs. The computer system 301 in some cases can include one or more additional data storage units that are external to the computer system 301, such as located on a remote server that is in communication with the computer system 301 through an intranet or the Internet.

The computer system 301 can communicate with one or more remote computer systems through the network 330. For instance, the computer system 301 can communicate with a remote computer system of a user (e.g., an end user, a consumer, a driver, a vehicle operator, and the like). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 301 via the network 330.

Methods as described herein can be implemented by way of machine (e.g., computer processor) executable code stored on an electronic storage location of the computer system 301, such as, for example, on the memory 310 or electronic storage unit 315. The machine executable or machine readable code can be provided in the form of software. During use, the code can be executed by the processor 305. In some cases, the code can be retrieved from the storage unit 315 and stored on the memory 310 for ready access by the processor 305. In some situations, the electronic storage unit 315 can be precluded, and machine-executable instructions are stored on memory 310. The code can be pre-compiled and configured for use with a machine having a processor adapted to execute the code or can be compiled during runtime. The code can be supplied in a programming language that can be selected to enable the code to execute in a pre-compiled or as-compiled fashion.

Aspects of the systems and methods provided herein, such as the computer system 301, can be embodied in programming. Various aspects of the technology may be thought of as “products” or “articles of manufacture” typically in the form of machine (or processor) executable code or associated data that is carried on or embodied in a type of machine-readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, and the like, shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code or data. Many of these forms of computer readable media may be involved in carrying one or more sequences of one or more instructions to a processor for execution.

The computer system 301 can include or be in communication with an electronic display 335 that comprises a UI 340 for providing, for example, a portal for monitoring one or more objects, obstacles, or targets detected by the radar system. In some cases, the portal may be used to render, view, monitor, or manipulate one or more occupancy grid maps generated by the processor or the plurality of radar modules. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 305. For examples, the algorithm may be configured to execute the process 400 described below.

### Example Process

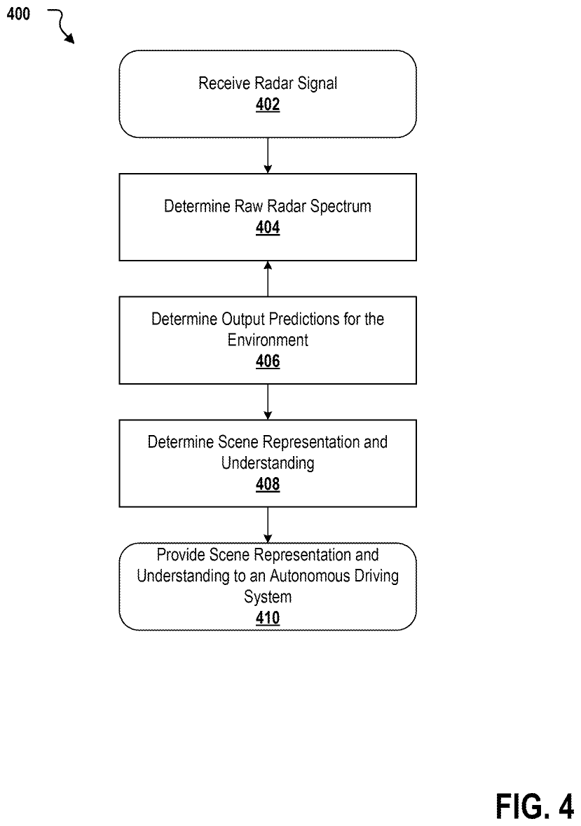

FIG. 4 depicts a flowchart of an example process 400 that can be implemented by embodiments of the present disclosure. The example process 400 can be implemented by the components of the described radar signals processing system, such as described above in FIGS. 1 and 2. The example process 400 generally shows in more detail how a 3D scene representation of an environment is determined by processing incoming radar signals through a machine-learning computational model.

For clarity of presentation, the description that follows generally describes the example process 400 in the context of FIGS. 1-3. However, it will be understood that the process 400 may be performed, for example, by any other suitable system, environment, software, and hardware, or a combination of systems, environments, software, and hardware as appropriate. In some embodiments, various operations of the process 400 can be run in parallel, in combination, in loops, or in any order.

At 402, an incoming radar signal is received from a radar module associated with a vehicle located in an environment. The radar signal comprises digitized radar samples that include a first indication of objects in the environment. From 402, the process 400 proceeds to 404.

At 404, the incoming radar signal is processed through one or more signal processing algorithms to determine a raw radar spectrum. From 404, the process 400 proceeds to 406.

At 406, the raw radar spectrum is processed through a machine-learning computational model to determine a set of output predictions for the environment. In some embodiment, input to the machine-learning computational model includes the most recent N frames, where N could be 1, 2, 3, 4, 5, 6, 7, 8, or another integer number of frames. From 406, the process 400 proceeds to 408.

At 408, a scene representation and a scene understanding are determined based at least in part on the set of output predictions for the environment. In some embodiment, the scene understanding includes target object class (vehicle, pedestrian, bicycle, truck, motorcycle, background, and the like), object bounding box, object ground velocity (e.g., two-dimensional (2D) or three-dimensional (3D)), object orientation, object direction of travel, ego-velocity (e.g., 2D or 3D). From 408, the process 400 proceeds to 410.

At 410, the scene representation and the scene understanding are provided to an autonomous driving system. From 410, the process 400 ends.

### Non-transitory Computer Readable Storage Medium

In some embodiments, the platforms, systems, media, and methods disclosed herein include one or more non-transitory computer readable storage media encoded with a program including instructions executable by the operating system of an optionally networked computer. In further embodiments, a computer readable storage medium is a tangible component of a computer. In still further embodiments, a computer readable storage medium is optionally removable from a computer. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the computer's CPU, written to perform a specified task. Computer readable instructions may be implemented as program modules, such as functions, objects, API, data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Machine Learning

As described above, machine learning algorithms are employed herein to build a model to determine a set of output predictions for the environment. Examples of machine learning algorithms may include a support vector machine (SVM), a naïve Bayes classification, a random forest, a neural network, deep learning, or other supervised learning algorithm or unsupervised learning algorithm for classification and regression. The machine learning algorithms may be trained using one or more training datasets. For example, previously received contextual data may be employed to train various algorithms. Moreover, as described above, these algorithms can be continuously trained/retrained using real-time user data as it is received. In some embodiments, the machine learning algorithm employs regression modelling where relationships between variables are determined and weighted. In some embodiments, the machine learning algorithm employ regression modelling, wherein relationships between predictor variables and dependent variables are determined and weighted.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the disclosure shall also cover any such alternatives, modifications, variations, or equivalents. It is intended that the following claims define the scope of the disclosure and that methods and structures within the scope of these claims and their equivalents be covered thereby.

### Examples

The following paragraphs provide various examples of the embodiments disclosed herein.

Example 1 is a computer-implemented method for processing radar signals. The method is executed by an electronic processor. The method includes receiving, from a radar module associated with a vehicle located in an environment, an incoming radar signal comprising digitized radar samples that include a first indication of objects in the environment; processing the incoming radar signal through one or more signal processing algorithms to determine a raw radar spectrum; processing the raw radar spectrum through a machine-learning computational model to determine a set of output predictions for the environment; determining a scene representation and a scene understanding based at least in part on the set of output predictions for the environment; and providing the scene representation and the scene understanding to an autonomous driving system.

Example 2 includes the subject matter of Example 1, and further specifies that the scene representation is generated at least in part using signal processing techniques such as detection, parameter estimation, and model fitting.

Example 3 includes the subject matter of Example 1 or 2, and further specifies that the scene representation is generated at least in part by the machine-learning computational model.

Example 4 includes the subject matter of any of Examples 1-3, and further specifies that the scene representation is determined by combining a first scene representation generated using signal processing techniques and a second scene representation generated by the machine-learning computational model.

Example 5 includes the subject matter of any of Examples 1-4, and further specifies that the scene representation comprises a parametrized model showing spatial relationships.

Example 6 includes the subject matter of any of Examples 1-5, and further specifies that the scene representation includes one or more of the following: a 2D point cloud, a 3D point cloud, a point cloud with additional metadata such as radial velocity or time, a list of object bounding boxes, an occupancy grid, a free space map, a drivable area map, a range-Doppler spectrum, or a beam spectrum.

Example 7 includes the subject matter of any of Examples 1-6, and further specifies that the scene understanding includes a representation of object properties given a context of a respective scene.

Example 8 includes the subject matter of any of Examples 1-7, and further specifies that the scene understanding includes one or more of the following properties: target object class, object bounding box, object ground velocity, object orientation, object direction of travel, or ego-velocity.

Example 9 includes the subject matter of any of Examples 1-8, and further specifies that the incoming radar signal is processed through range and Doppler processing.

Example 10 includes the subject matter of any of Examples 1-9, and further specifies that the machine-learning computational model is trained with a range-Doppler spectrum as input.

Example 11 includes the subject matter of any of Examples 1-10, and further specifies that the incoming radar signal is processed through range and Doppler processing and beamforming.

Example 12 includes the subject matter of any of Examples 1-11, and further specifies that input to the machine-learning computational model includes a beam spectrum.

Example 13 includes the subject matter of any of Examples 1-12, and further specifies that input to the machine-learning computational model includes a point cloud, a Cartesian projection of a point cloud, an occupancy grid, or a previously determined scene representation of the environment.

Example 14 includes the subject matter of any of Examples 1-13, and further specifies that the radar module is configured to: transmit a first set of signals comprising a plurality of outgoing radar pulses, and receive the incoming radar signal.

Example 15 includes the subject matter of any of Examples 1-14, and further specifies that the incoming radar signal is a subset of the first set of signals and comprises a plurality of incoming radar pulses.

Example 16 includes the subject matter of any of Examples 1-15, and further specifies that the incoming radar signal is generated upon the subset of the first set of signals interacting with or reflecting off of at least one of the objects in the environment.

Example 17 includes the subject matter of any of Examples 1-16, and further specifies that the machine-learning computational model is configured to determine object class labels for the objects in the environment.

Example 18 includes the subject matter of any of Examples 1-17, and further specifies that the object class labels are integrated in the scene representation to provide context for the objects and the environment.

Example 19 includes the subject matter of any of Examples 1-18, and further includes receiving, from a plurality of imaging devices, image data that include a second indication of the objects in the environment, and processing the raw radar spectrum and the image data through the machine-learning computational model to produce the set of output predictions for the environment.

Example 20 includes the subject matter of any of Examples 1-19, and further specifies that input to the machine-learning computational model includes time history data received from at least one of the imaging devices or the radar module.

Example 21 includes the subject matter of any of Examples 1-20, and further includes receiving, from a LIDAR sensor, LIDAR data that includes a second indication of the objects in the environment, and processing the raw radar spectrum and the LIDAR data through the machine-learning computational model to produce the set of output predictions for the environment.

Example 22 includes the subject matter of any of Examples 1-21, and further specifies that the raw radar spectrum includes a sequence of radar frames.

Example 23 includes the subject matter of any of Examples 1-22, and further specifies that the machine-learning computational model outputs the set of output predictions based on the sequence of radar frames.

Example 24 includes the subject matter of any of Examples 1-23, and further specifies that the sequence of radar frames comprises a continuous time sequence or a non-continuous time sequence.

Example 25 includes the subject matter of any of Examples 1-24, and further specifies that input to the machine-learning computational model includes the most recent N frames of the sequence of radar frames.

Example 26 includes the subject matter of any of Examples 1-25, and further includes receiving, from a plurality of radar modules associated with the vehicle located in the environment, a plurality of incoming radar signals that include the first indication of the objects in the environment, and processing the incoming radar signal through the one or more signal processing algorithms to determine the raw radar spectrum.

Example 27 includes the subject matter of any of Examples 1-26, and further specifies that the radar modules include at least one corner-facing radar and one front-facing radar or at least one rear corner-facing radar and one rear-facing radar

Example 28 includes the subject matter of any of Examples 1-27, and further specifies that the radar modules include at least two front-facing radars or at least two rear-facing radars.

Example 29 includes the subject matter of any of Examples 1-28, and further specifies that the machine-learning computational model is trained with ground truth labels using a supervised method.

Example 30 includes the subject matter of any of Examples 1-29, and further specifies that the machine-learning computational model is trained using an unsupervised or self-supervised method by learning how to reconstruct a raw radar signal from a plurality of radar modules or from multiple data points in time.

Example 31 includes the subject matter of any of Examples 1-30, and further specifies that the autonomous driving system includes an emergency braking system, an ADAS, or an active safety system.

Example 32 includes the subject matter of any of Examples 1-31, and further specifies that the machine-learning computational model comprises a neural network model, a CNN model, an LSTM, or a ViT model.

Example 33 includes the subject matter of any of Examples 1-32, and further specifies that the vehicle is moving through the environment.

Example 34 includes the subject matter of any of Examples 1-33, and further specifies that the vehicle comprises a self-driving vehicle or an autonomous vehicle.

Example 35 includes the subject matter of any of Examples 1-34, and further specifies that the autonomous driving system is associated with or integrated into the vehicle.

Example 36 includes the subject matter of any of Examples 1-35, and further specifies that the radar module is mounted to the vehicle and comprises a radar transmitter and a radar receiver.

Example 37 is a non-transitory computer-readable medium including instructions executable by an electronic processor to perform a set of functions. The set of functions includes receiving, from a radar module, an incoming radar signal comprising digitized radar samples that include a first indication of objects in an environment; receiving, from a plurality of imaging devices, image data that include a second indication of the objects in the environment; processing the image data and a raw radar spectrum through a machine-learning computational model to determine a set of output predictions for the environment, wherein the raw radar spectrum is determined according to the incoming radar signal; determining a scene representation and a scene understanding based at least in part on the set of output predictions for the environment; and providing the scene representation and the scene understanding to an autonomous driving system.

Example 38 includes the subject matter of Example 37, and further specifies that the scene representation is generated at least in part using signal processing techniques such as detection, parameter estimation, and model fitting.

Example 39 includes the subject matter of Example 37 or 38, and further specifies that the scene representation is generated at least in part by the machine-learning computational model.

Example 40 includes the subject matter of any of Examples 37-39, and further specifies that the scene representation is determined by combining a first scene representation generated using signal processing techniques and a second scene representation generated by the machine-learning computational model.

Example 41 includes the subject matter of any of Examples 37-40, and further specifies that the scene representation comprises a parametrized model showing spatial relationships.

Example 42 includes the subject matter of any of Examples 37-41, and further specifies that the scene representation includes one or more of the following: a 2D point cloud, a 3D point cloud, a point cloud with additional metadata such as radial velocity or time, a list of object bounding boxes, an occupancy grid, a free space map, a drivable area map, a range-Doppler spectrum, or a beam spectrum.

Example 43 includes the subject matter of any of Examples 37-42, and further specifies that the scene understanding includes a representation of object properties given a context of a respective scene.

Example 44 includes the subject matter of any of Examples 37-43, and further specifies that the scene understanding includes one or more of the following properties: target object class, object bounding box, object ground velocity, object orientation, object direction of travel, or ego-velocity.

Example 45 includes the subject matter of any of Examples 37-44, and further specifies that the incoming radar signal is processed through range and Doppler processing.

Example 46 includes the subject matter of any of Examples 37-45, and further specifies that the machine-learning computational model is trained with a range-Doppler spectrum as input.

Example 47 includes the subject matter of any of Examples 37-46, and further specifies that the incoming radar signal is processed through range and Doppler processing and beamforming.

Example 48 includes the subject matter of any of Examples 37-47, and further specifies that input to the machine-learning computational model includes a beam spectrum.

Example 49 includes the subject matter of any of Examples 37-48, and further specifies that input to the machine-learning computational model includes a point cloud, a Cartesian projection of a point cloud, an occupancy grid, or a previously determined scene representation of the environment.

Example 50 includes the subject matter of any of Examples 37-49, and further specifies that the radar module is configured to: transmit a first set of signals comprising a plurality of outgoing radar pulses, and receive the incoming radar signal.

Example 51 includes the subject matter of any of Examples 37-50, and further specifies that the incoming radar signal is a subset of the first set of signals and comprises a plurality of incoming radar pulses.

Example 52 includes the subject matter of any of Examples 37-51, and further specifies that the incoming radar signal is generated upon the subset of the first set of signals interacting with or reflecting off of at least one of the objects in the environment.

Example 53 includes the subject matter of any of Examples 37-52, and further specifies that the machine-learning computational model is configured to determine object class labels for the objects in the environment.

Example 54 includes the subject matter of any of Examples 37-53, and further specifies that the object class labels are integrated in the scene representation to provide context for the objects and the environment.

Example 55 includes the subject matter of any of Examples 37-54, and further specifies that input to the machine-learning computational model includes time history data received from at least one of the imaging devices or the radar module.

Example 56 includes the subject matter of any of Examples 37-55, and further specifies that the set of functions includes receiving, from a LIDAR sensor, LIDAR data that includes a second indication of the objects in the environment, and processing the raw radar spectrum and the LIDAR data through the machine-learning computational model to produce the set of output predictions for the environment.

Example 57 includes the subject matter of any of Examples 37-56, and further specifies that the raw radar spectrum includes a sequence of radar frames.

Example 58 includes the subject matter of any of Examples 37-57, and further specifies that the machine-learning computational model outputs the set of output predictions based on the sequence of radar frames.

Example 59 includes the subject matter of any of Examples 37-58, and further specifies that the sequence of radar frames comprises a continuous time sequence or a non-continuous time sequence.

Example 60 includes the subject matter of any of Examples 37-59, and further specifies that input to the machine-learning computational model includes the most recent N frames of the sequence of radar frames.

Example 61 includes the subject matter of any of Examples 37-60, and further specifies that the set of functions includes receiving, from a plurality of radar modules associated with the vehicle located in the environment, a plurality of incoming radar signals that include the first indication of the objects in the environment, and processing the incoming radar signal through the one or more signal processing algorithms to determine the raw radar spectrum.

Example 62 includes the subject matter of any of Examples 37-61, and further specifies that the radar modules include at least one corner-facing radar and one front-facing radar or at least one rear corner-facing radar and one rear-facing radar

Example 63 includes the subject matter of any of Examples 37-62, and further specifies that the radar modules include at least two front-facing radars or at least two rear-facing radars.

Example 64 includes the subject matter of any of Examples 37-63, and further specifies that the machine-learning computational model is trained with ground truth labels using a supervised method.

Example 65 includes the subject matter of any of Examples 37-64, and further specifies that the machine-learning computational model is trained using an unsupervised or self-supervised method by learning how to reconstruct a raw radar signal from a plurality of radar modules or from multiple data points in time.

Example 66 includes the subject matter of any of Examples 37-65, and further specifies that the autonomous driving system includes an emergency braking system, an ADAS, or an active safety system.

Example 67 includes the subject matter of any of Examples 37-66, and further specifies that the machine-learning computational model comprises a neural network model, a CNN model, an LSTM, or a ViT model.

Example 68 includes the subject matter of any of Examples 37-67, and further specifies that the vehicle is moving through the environment.

Example 69 includes the subject matter of any of Examples 37-68, and further specifies that the vehicle comprises a self-driving vehicle or an autonomous vehicle.

Example 70 includes the subject matter of any of Examples 37-69, and further specifies that the autonomous driving system is associated with or integrated into the vehicle.

Example 71 includes the subject matter of any of Examples 37-70, and further specifies that the radar module is mounted to the vehicle and comprises a radar transmitter and a radar receiver.

Example 72 is a non-transitory computer-readable medium including instructions executable by an electronic processor to perform a set of functions. The set of functions includes receiving, from a radar module, an incoming radar signal comprising digitized radar samples that include a first indication of objects in an environment; receiving, from a LIDAR sensor, LIDAR data that includes a second indication of the objects in the environment; processing the LIDAR data and a raw radar spectrum through a machine-learning computational model to determine a set of output predictions for the environment, wherein the raw radar spectrum is determined according to the incoming radar signal; determining a scene representation and a scene understanding based at least in part on the set of output predictions for the environment; and providing the scene representation and the scene understanding to an autonomous driving system.

Example 73 includes the subject matter of Example 72, and further specifies that the scene representation is generated at least in part using signal processing techniques such as detection, parameter estimation, and model fitting.

Example 74 includes the subject matter of Example 72 or 73, and further specifies that the scene representation is generated at least in part by the machine-learning computational model.

Example 75 includes the subject matter of any of Examples 72-74, and further specifies that the scene representation is determined by combining a first scene representation generated using signal processing techniques and a second scene representation generated by the machine-learning computational model.

Example 76 includes the subject matter of any of Examples 72-75, and further specifies that the scene representation comprises a parametrized model showing spatial relationships.

Example 77 includes the subject matter of any of Examples 72-76, and further specifies that the scene representation includes one or more of the following: a 2D point cloud, a 3D point cloud, a point cloud with additional metadata such as radial velocity or time, a list of object bounding boxes, an occupancy grid, a free space map, a drivable area map, a range-Doppler spectrum, or a beam spectrum.

Example 78 includes the subject matter of any of Examples 72-77, and further specifies that the scene understanding includes a representation of object properties given a context of a respective scene.

Example 79 includes the subject matter of any of Examples 72-78, and further specifies that the scene understanding includes one or more of the following properties: target object class, object bounding box, object ground velocity, object orientation, object direction of travel, or ego-velocity.

Example 80 includes the subject matter of any of Examples 72-79, and further specifies that the incoming radar signal is processed through range and Doppler processing.

Example 81 includes the subject matter of any of Examples 72-80, and further specifies that the machine-learning computational model is trained with a range-Doppler spectrum as input.

Example 82 includes the subject matter of any of Examples 72-81, and further specifies that the incoming radar signal is processed through range and Doppler processing and beamforming.

Example 83 includes the subject matter of any of Examples 72-82, and further specifies that input to the machine-learning computational model includes a beam spectrum.

Example 84 includes the subject matter of any of Examples 72-83, and further specifies that input to the machine-learning computational model includes a point cloud, a Cartesian projection of a point cloud, an occupancy grid, or a previously determined scene representation of the environment.

Example 85 includes the subject matter of any of Examples 72-84, and further specifies that the radar module is configured to: transmit a first set of signals comprising a plurality of outgoing radar pulses, and receive the incoming radar signal.

Example 86 includes the subject matter of any of Examples 72-85, and further specifies that the incoming radar signal is a subset of the first set of signals and comprises a plurality of incoming radar pulses.

Example 87 includes the subject matter of any of Examples 72-86, and further specifies that the incoming radar signal is generated upon the subset of the first set of signals interacting with or reflecting off of at least one of the objects in the environment.

Example 88 includes the subject matter of any of Examples 72-87, and further specifies that the machine-learning computational model is configured to determine object class labels for the objects in the environment.

Example 89 includes the subject matter of any of Examples 72-88, and further specifies that the object class labels are integrated in the scene representation to provide context for the objects and the environment.

Example 90 includes the subject matter of any of Examples 72-89, and further specifies includes receiving, from a plurality of imaging devices, image data that include a second indication of the objects in the environment, and processing the raw radar spectrum and the image data through the machine-learning computational model to produce the set of output predictions for the environment.

Example 91 includes the subject matter of any of Examples 72-90, and further specifies that input to the machine-learning computational model includes time history data received from at least one of the imaging devices or the radar module.

Example 92 includes the subject matter of any of Examples 72-91, and further specifies that the raw radar spectrum includes a sequence of radar frames.

Example 93 includes the subject matter of any of Examples 72-92, and further specifies that the machine-learning computational model outputs the set of output predictions based on the sequence of radar frames.

Example 94 includes the subject matter of any of Examples 72-93, and further specifies that the sequence of radar frames comprises a continuous time sequence or a non-continuous time sequence.

Example 95 includes the subject matter of any of Examples 72-94, and further specifies that input to the machine-learning computational model includes the most recent N frames of the sequence of radar frames.

Example 96 includes the subject matter of any of Examples 72-95, and further specifies that the set of functions includes receiving, from a plurality of radar modules associated with the vehicle located in the environment, a plurality of incoming radar signals that include the first indication of the objects in the environment, and processing the incoming radar signal through the one or more signal processing algorithms to determine the raw radar spectrum.

Example 97 includes the subject matter of any of Examples 72-96, and further specifies that the radar modules include at least one corner-facing radar and one front-facing radar or at least one rear corner-facing radar and one rear-facing radar

Example 98 includes the subject matter of any of Examples 72-97, and further specifies that the radar modules include at least two front-facing radars or at least two rear-facing radars.

Example 99 includes the subject matter of any of Examples 72-98, and further specifies that the machine-learning computational model is trained with ground truth labels using a supervised method.

Example 100 includes the subject matter of any of Examples 72-99, and further specifies that the machine-learning computational model is trained using an unsupervised or self-supervised method by learning how to reconstruct a raw radar signal from a plurality of radar modules or from multiple data points in time.

Example 101 includes the subject matter of any of Examples 72-100, and further specifies that the autonomous driving system includes an emergency braking system, an ADAS, or an active safety system.

Example 102 includes the subject matter of any of Examples 72-101, and further specifies that the machine-learning computational model comprises a neural network model, a CNN model, an LSTM, or a ViT model.

Example 103 includes the subject matter of any of Examples 72-102, and further specifies that the vehicle is moving through the environment.

Example 104 includes the subject matter of any of Examples 72-103, and further specifies that the vehicle comprises a self-driving vehicle or an autonomous vehicle.

Example 105 includes the subject matter of any of Examples 72-104, and further specifies that the autonomous driving system is associated with or integrated into the vehicle.

Example 106 includes the subject matter of any of Examples 72-105, and further specifies that the radar module is mounted to the vehicle and comprises a radar transmitter and a radar receiver.

Example 107 is a radar signal processing system that includes a vehicle located in an environment, a radar module associated with the vehicle, and an electronic processor. The electronic processor is configured to receive, from the radar module, an incoming radar signal comprising digitized radar samples that include a first indication of objects in the environment; process the incoming radar signal through one or more signal processing algorithms to determine a raw radar spectrum; process the raw radar spectrum through a machine-learning computational model to determine a set of output predictions for the environment; determine a scene representation and a scene understanding based at least in part on the set of output predictions for the environment; and provide the scene representation and the scene understanding to an autonomous driving system.

Example 108 includes the subject matter of Example 107, and further specifies that the scene representation is generated at least in part using signal processing techniques such as detection, parameter estimation, and model fitting.

Example 109 includes the subject matter of Example 107 or 108, and further specifies that the scene representation is generated at least in part by the machine-learning computational model.

Example 110 includes the subject matter of any of Examples 107-109, and further specifies that the scene representation is determined by combining a first scene representation generated using signal processing techniques and a second scene representation generated by the machine-learning computational model.

Example 111 includes the subject matter of any of Examples 107-110, and further specifies that the scene representation comprises a parametrized model showing spatial relationships.

Example 112 includes the subject matter of any of Examples 107-111, and further specifies that the scene representation includes one or more of the following: a 2D point cloud, a 3D point cloud, a point cloud with additional metadata such as radial velocity or time, a list of object bounding boxes, an occupancy grid, a free space map, a drivable area map, a range-Doppler spectrum, or a beam spectrum.

Example 113 includes the subject matter of any of Examples 107-112, and further specifies that the scene understanding includes a representation of object properties given a context of a respective scene.

Example 114 includes the subject matter of any of Examples 107-113, and further specifies that the scene understanding includes one or more of the following properties: target object class, object bounding box, object ground velocity, object orientation, object direction of travel, or ego-velocity.

Example 115 includes the subject matter of any of Examples 107-114, and further specifies that the incoming radar signal is processed through range and Doppler processing.

Example 116 includes the subject matter of any of Examples 107-115, and further specifies that the machine-learning computational model is trained with a range-Doppler spectrum as input.

Example 117 includes the subject matter of any of Examples 107-116, and further specifies that the incoming radar signal is processed through range and Doppler processing and beamforming.

Example 118 includes the subject matter of any of Examples 107-117, and further specifies that input to the machine-learning computational model includes a beam spectrum.

Example 119 includes the subject matter of any of Examples 107-118, and further specifies that input to the machine-learning computational model includes a point cloud, a Cartesian projection of a point cloud, an occupancy grid, or a previously determined scene representation of the environment.

Example 120 includes the subject matter of any of Examples 107-119, and further specifies that the radar module is configured to: transmit a first set of signals comprising a plurality of outgoing radar pulses, and receive the incoming radar signal.

Example 121 includes the subject matter of any of Examples 107-120, and further specifies that the incoming radar signal is a subset of the first set of signals and comprises a plurality of incoming radar pulses.

Example 122 includes the subject matter of any of Examples 107-121, and further specifies that the incoming radar signal is generated upon the subset of the first set of signals interacting with or reflecting off of at least one of the objects in the environment.

Example 123 includes the subject matter of any of Examples 107-122, and further specifies that the machine-learning computational model is configured to determine object class labels for the objects in the environment.

Example 124 includes the subject matter of any of Examples 107-123, and further specifies that the object class labels are integrated in the scene representation to provide context for the objects and the environment.

Example 125 includes the subject matter of any of Examples 107-124, and further specifies that the electronic processor is configured to receive, from a plurality of imaging devices, image data that include a second indication of the objects in the environment, and process the raw radar spectrum and the image data through the machine-learning computational model to produce the set of output predictions for the environment.

Example 126 includes the subject matter of any of Examples 107-125, and further specifies that input to the machine-learning computational model includes time history data received from at least one of the imaging devices or the radar module.

Example 127 includes the subject matter of any of Examples 107-126, and further specifies that the electronic processor is configured to receive, from a LIDAR sensor, LIDAR data that includes a second indication of the objects in the environment, and process the raw radar spectrum and the LIDAR data through the machine-learning computational model to produce the set of output predictions for the environment.

Example 128 includes the subject matter of any of Examples 107-127, and further specifies that the raw radar spectrum includes a sequence of radar frames.

Example 129 includes the subject matter of any of Examples 107-128, and further specifies that the machine-learning computational model outputs the set of output predictions based on the sequence of radar frames.

Example 130 includes the subject matter of any of Examples 107-129, and further specifies that the sequence of radar frames comprises a continuous time sequence or a non-continuous time sequence.

Example 131 includes the subject matter of any of Examples 107-130, and further specifies that input to the machine-learning computational model includes the most recent N frames of the sequence of radar frames.

Example 132 includes the subject matter of any of Examples 107-131, and further specifies that the electronic processor is configured to receive, from a plurality of radar modules associated with the vehicle located in the environment, a plurality of incoming radar signals that include the first indication of the objects in the environment, and process the incoming radar signal through the one or more signal processing algorithms to determine the raw radar spectrum.

Example 133 includes the subject matter of any of Examples 107-132, and further specifies that the radar modules include at least one corner-facing radar and one front-facing radar or at least one rear corner-facing radar and one rear-facing radar

Example 134 includes the subject matter of any of Examples 107-133, and further specifies that the radar modules include at least two front-facing radars or at least two rear-facing radars.

Example 135 includes the subject matter of any of Examples 107-134, and further specifies that the machine-learning computational model is trained with ground truth labels using a supervised method.

Example 136 includes the subject matter of any of Examples 107-135, and further specifies that the machine-learning computational model is trained using an unsupervised or self-supervised method by learning how to reconstruct a raw radar signal from a plurality of radar modules or from multiple data points in time.

Example 137 includes the subject matter of any of Examples 107-136, and further specifies that the autonomous driving system includes an emergency braking system, an ADAS, or an active safety system.

Example 138 includes the subject matter of any of Examples 107-137, and further specifies that the machine-learning computational model comprises a neural network model, a CNN model, an LSTM, or a ViT model.

Example 139 includes the subject matter of any of Examples 107-138, and further specifies that the vehicle is moving through the environment.

Example 140 includes the subject matter of any of Examples 107-139, and further specifies that the vehicle comprises a self-driving vehicle or an autonomous vehicle.

Example 141 includes the subject matter of any of Examples 107-140, and further specifies that the autonomous driving system is associated with or integrated into the vehicle.

Example 142 includes the subject matter of any of Examples 107-141, and further specifies that the radar module is mounted to the vehicle and comprises a radar transmitter and a radar receiver.

What is claimed is:

1. A computer-implemented method for processing radar signals, the method being executed by an electronic processor and comprising:
receiving, from a radar module associated with a vehicle located in an environment, an incoming radar signal comprising digitized radar samples that include a first indication of objects in the environment;
processing the incoming radar signal through one or more signal processing algorithms to determine a raw radar spectrum;
processing the raw radar spectrum through a machine-learning computational model to determine a set of output predictions for the environment;
determining a scene representation and a scene understanding based at least in part on the set of output predictions for the environment; and
providing the scene representation and the scene understanding to an autonomous driving system.

2. The method of claim 1, wherein the scene representation is generated at least in part using signal processing techniques such as detection, parameter estimation, and model fitting.

3. The method of claim 1, wherein the scene representation is generated at least in part by the machine-learning computational model.

4. The method of claim 1, wherein the scene representation is determined by combining a first scene representation generated using signal processing techniques and a second scene representation generated by the machine-learning computational model.

5. The method of claim 1, wherein the scene representation comprises a parametrized model showing spatial relationships.

6. The method of claim 1, wherein the scene representation includes one or more of the following: a two-dimensional (2D) point cloud, a three-dimensional (3D) point cloud, a point cloud with additional metadata such as radial velocity or time, a list of object bounding boxes, an occupancy grid, a free space map, a drivable area map, a range-Doppler spectrum, or a beam spectrum.

7. The method of claim 1, wherein the scene understanding comprises a representation of object properties given a context of a respective scene.

8. The method of claim 1, wherein the scene understanding includes one or more of the following properties: target object class, object bounding box, object ground velocity, object orientation, object direction of travel, or ego-velocity.

9. The method of claim 1, wherein the incoming radar signal is processed through range and Doppler processing, and wherein the machine-learning computational model is trained with a range-Doppler spectrum as input.

10. The method of claim 1, wherein the incoming radar signal is processed through range and Doppler processing and beamforming, and wherein input to the machine-learning computational model includes a beam spectrum.

11. The method of claim 1, wherein input to the machine-learning computational model includes a point cloud, a Cartesian projection of a point cloud, an occupancy grid, or a previously determined scene representation of the environment.

12. The method of claim 1, wherein the radar module is configured to:
transmit a first set of signals comprising a plurality of outgoing radar pulses, and
receive the incoming radar signal, wherein the incoming radar signal is a subset of the first set of signals and comprises a plurality of incoming radar pulses, and wherein the incoming radar signal is generated upon the subset of the first set of signals interacting with or reflecting off of at least one of the objects in the environment.

13. The method of claim 1, wherein the machine-learning computational model is configured to determine object class labels for the objects in the environment, and wherein the object class labels are integrated in the scene representation to provide context for the objects and the environment.

14. The method of claim 1, further comprising:
receiving, from a plurality of imaging devices, image data that include a second indication of the objects in the environment, and
processing the raw radar spectrum and the image data through the machine-learning computational model to produce the set of output predictions for the environment.

15. The method of claim 14, wherein input to the machine-learning computational model includes time history data received from at least one of the imaging devices or the radar module.

16. The method of claim 1, further comprising:
receiving, from a Light Detection and Ranging (LIDAR) sensor, LIDAR data that includes a second indication of the objects in the environment, and
processing the raw radar spectrum and the LIDAR data through the machine-learning computational model to produce the set of output predictions for the environment.

17. The method of claim 1, wherein the raw radar spectrum includes a sequence of radar frames, wherein the machine-learning computational model outputs the set of output predictions based on the sequence of radar frames, wherein the sequence of radar frames comprises a continuous time sequence or a non-continuous time sequence, and wherein input to the machine-learning computational model includes the most recent N frames of the sequence of radar frames.

18. The method of claim 1, further comprising:
receiving, from a plurality of radar modules associated with the vehicle located in the environment, a plurality of incoming radar signals that include the first indication of the objects in the environment, and
processing the incoming radar signal through the one or more signal processing algorithms to determine the raw radar spectrum.

19. The method of claim 18, wherein the radar modules include at least one corner-facing radar and one front-facing radar or at least one rear corner-facing radar and one rear-facing radar

20. The method of claim 18, wherein the radar modules include at least two front-facing radars or at least two rear-facing radars.

21. The method of claim 1, wherein the machine-learning computational model is trained with ground truth labels using a supervised method.

22. The method of claim 1, wherein the machine-learning computational model is trained using an unsupervised or self-supervised method by learning how to reconstruct a raw radar signal from a plurality of radar modules or from multiple data points in time.

23. The method of claim 1, wherein the autonomous driving system includes an emergency braking system, an advance driving assistant system (ADAS), or an active safety system.

24. The method of claim 1, wherein the machine-learning computational model comprises a neural network model, a convolutional neural network (CNN) model, a long short-term memory (LSTM), or a Vision Transformer (ViT) model.

25. A non-transitory computer-readable medium including instructions executable by an electronic processor to perform a set of functions, the set of functions comprising:
receiving, from a radar module, an incoming radar signal comprising digitized radar samples that include a first indication of objects in an environment;
receiving, from a plurality of imaging devices, image data that include a second indication of the objects in the environment;
processing the image data and a raw radar spectrum through a machine-learning computational model to determine a set of output predictions for the environment, wherein the raw radar spectrum is determined according to the incoming radar signal;
determining a scene representation and a scene understanding based at least in part on the set of output predictions for the environment; and
providing the scene representation and the scene understanding to an autonomous driving system.

26. A non-transitory computer-readable medium including instructions executable by an electronic processor to perform a set of functions, the set of functions comprising:
receiving, from a radar module, an incoming radar signal comprising digitized radar samples that include a first indication of objects in an environment;
receiving, from a Light Detection and Ranging (LIDAR) sensor, LIDAR data that includes a second indication of the objects in the environment;
processing the LIDAR data and a raw radar spectrum through a machine-learning computational model to determine a set of output predictions for the environment, wherein the raw radar spectrum is determined according to the incoming radar signal;
determining a scene representation and a scene understanding based at least in part on the set of output predictions for the environment; and
providing the scene representation and the scene understanding to an autonomous driving system.

27. A radar signal processing system, comprising:
a vehicle located in an environment;
a radar module associated with the vehicle; and
an electronic processor configured to:
receive, from the radar module, an incoming radar signal comprising digitized radar samples that include a first indication of objects in the environment;
process the incoming radar signal through one or more signal processing algorithms to determine a raw radar spectrum;
process the raw radar spectrum through a machine-learning computational model to determine a set of output predictions for the environment;
determine a scene representation and a scene understanding based at least in part on the set of output predictions for the environment; and
provide the scene representation and the scene understanding to an autonomous driving system.

28. The system of claim 27, wherein the vehicle is moving through the environment.

29. The system of claim 27, wherein the vehicle comprises a self-driving vehicle or an autonomous vehicle, and wherein the autonomous driving system is associated with or integrated into the vehicle.

30. The system of claim 27, wherein the radar module is mounted to the vehicle and comprises a radar transmitter and a radar receiver.
